(19) United States
(12) Patent Application Publication
(10) Pub. No.: US 2026/0162215 A1
(43) Pub. Date: Jun. 11, 2026

(54) METHOD FOR GENERATING A MIDDLE-RESOLUTION IMAGE

(71) Applicant: OmniVision Technologies, Inc., Santa Clara, CA (US)

(72) Inventors: Bo MU, San Jose, CA (US); Chengming LIU, Fremont, CA (US); Wei DENG, Sunnyvale, CA (US); Tiejun DAI, Santa Clara, CA (US)

(21) Appl. No.: 18/970,671

(22) Filed: Dec. 5, 2024

(51) Int. Cl. G06T 3/4015; G06T 3/4038; G06T 5/50; H04N 25/46

(52) U.S. Cl. CPC G06T 3/4015; G06T 3/4038; G06T 5/50; H04N 25/46; G06T 2207/20221

(57) ABSTRACT

A method for generating image data from a pixel cell of an image sensor includes pulsing a reset gate, of the pixel cell, that includes a zeroth pixel and a first pixel; generating a signal from the pixel cell by sequentially pulsing a zeroth transfer gate and a first transfer gate of the zeroth pixel and the first pixel, respectively; and abstaining from pulsing the reset gate of the pixel cell until each of the zeroth and the first transfer gate has been pulsed; sampling the signal to yield signals S0 and S1 and a reset-signal RST; determining a binned signal as a difference between signal S1 and reset-signal RST; determining a pixel signal PD0, output from the zeroth pixel, as a difference between signal S0 and reset-signal RST; and determining a pixel signal PD1, output from the first pixel, as a difference signal S1 and signal S0.

### BACKGROUND

Many high-resolution image sensors have a pixel layout in which multiple photodiodes share a common floating diffusion region. While such image sensors can produce high-resolution images, a disadvantage of such image sensors is that when capturing images in low-light conditions, the resulting images have a low signal-to-noise ratio (SNR), which degrades image quality. One method of overcoming this problem is known as binning, where signals generated by adjacent pixels are combined. While binning improves SNR, the resulting images have significantly lower resolution than the resolution attainable by the image sensor.

### SUMMARY OF THE EMBODIMENTS

Embodiments disclosed herein include a method and image sensor that generate a middle-resolution image, which achieves a good balance between resolution and SNR under low-light conditions.

In a first aspect, a method for generating image data from a pixel cell of an image sensor is disclosed. The method includes pulsing a reset gate, of the pixel cell, that includes a zeroth pixel and a first pixel; generating a signal from the pixel cell by sequentially pulsing a zeroth transfer gate and a first transfer gate of the zeroth pixel and the first pixel, respectively; and abstaining from pulsing the reset gate of the pixel cell until each of the zeroth transfer gate and the first transfer gate of the pixel cell has been pulsed. The method also includes sampling the signal after pulsing the zeroth transfer gate to yield a signal S0; sampling the signal after pulsing the first transfer gate to yield a signal S1; and sampling the signal after pulsing the reset gate to yield a reset signal RST. The method also includes determining a binned signal as a difference between the signal S1 and the reset signal RST; determining a pixel signal PD0, output from the zeroth pixel, as a difference between the signal S0 and the reset signal RST; and determining a pixel signal PD1, output from the first pixel, as a difference between the signal S1 and the signal S0.

In a second aspect, an image sensor is disclosed. The image sensor includes a pixel array and control circuitry. The pixel array has a plurality pixel cells of the first aspect. The control circuitry (i) is electrically connected to each of the plurality of pixel cells and (ii) executes the method of the first aspect for each of the plurality of pixel cells.

### BRIEF DESCRIPTION OF THE FIGURES

FIG. 1 depicts a camera imaging a scene.

FIG. 2 is a cross-sectional schematic of a pixel-array substrate, which is an embodiment of a pixel-array substrate of the camera of FIG. 1.

FIG. 3 is a circuit diagram of a pixel cell, which is a candidate pixel circuitry architecture of a pixel of FIG. 2.

FIG. 4 is a functional block diagram of an image sensor, embodiments of which include the pixel cell of FIG. 3.

FIG. 5 is a schematic of a pixel cell of embodiments of the image sensor of FIG. 4.

FIG. 6 is a schematic of a pixel array that includes pixel cells of FIG. 5, in an embodiment.

FIG. 7 is a schematic of a pixel cell of embodiments of the image sensor of FIG. 4.

FIG. 8 is a schematic of a pixel array that includes pixel cells of FIG. 7, in an embodiment.

FIG. 9 includes schematic plots of signals generated by the image sensor of FIG. 4, in embodiments.

FIG. 10 is a flowchart illustrating a method for generating image data from a pixel cell of the image sensor of FIG. 4, in an embodiment.

FIG. 11 is a data-flow diagram and FIGS. 12 and 13 are flowcharts illustrating embodiments of methods for generating a middle-resolution image using the image sensor of FIG. 4.

### DETAILED DESCRIPTION OF THE EMBODIMENTS

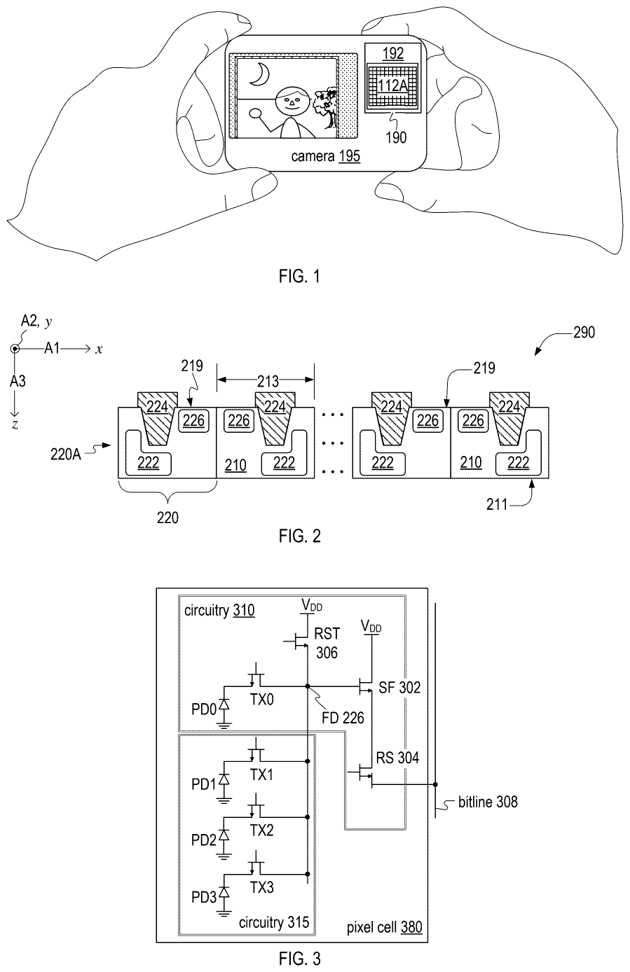

FIG. 1 depicts a camera 195 imaging a scene. Camera 195 includes an image sensor 192, which includes a pixel-array substrate 190. Constituent elements of pixel-array substrate 190 may include at least one of silicon and germanium. Pixel-array substrate 190 includes a pixel array 112A. Image sensor 192 may be part of a chip-scale package or a chip-on-board package. Camera 195 is shown as a component of a handheld device, but it should be appreciated that other devices, such as security devices, automobile cameras, and drone cameras, may utilize camera 195 without departing from the scope hereof.

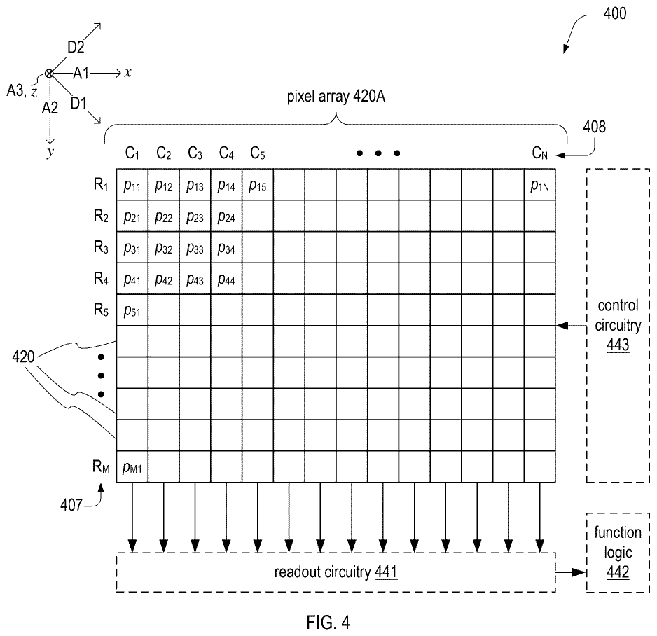

FIG. 2 is a cross-sectional schematic of a pixel-array substrate 290, which is an example of pixel-array substrate 190 of image sensor 192. The cross-section illustrated in FIG. 2 is parallel to a plane, hereinafter the x-z plane, formed by orthogonal axes A1 and A3, which are each orthogonal to an axis A2. Herein, the x-y plane is formed by orthogonal axes A1 and A2, and planes parallel to the x-y plane are referred to as transverse planes. Unless otherwise specified, heights of objects herein refer to the object's extent along axis A3. Herein, a reference to an axis x, y, or z refers to axes A1, A2, and A3, respectively. Also, herein, a horizontal plane is parallel to the x-y plane, a width refers to an object's extent along the x or y axis, respectively, and a vertical direction is along the z axis. FIG. 4 also denotes axes D1 and D2, which in embodiments are rotated by forty-five degrees with respect to axes A1 and A2, respectively, and denote respective directions of rows and columns of pixels 420 forming pixel array 420A.

Pixel-array substrate 290 includes a semiconductor substrate 210, which has a bottom substrate surface 211 and a front substrate surface 219, each of which may be perpendicular to axis A3. Herein, front substrate surface 219 may be referred to as the front side surface of semiconductor substrate 210 and bottom substrate surface 211 may be referred to as the backside surface of semiconductor substrate 210. Herein, front substrate surface 219 may be referred as the non-illuminated surface of semiconductor substrate 210 and bottom substrate surface 211 opposite to front substrate surface 219 may be referred to as the illuminated surface of semiconductor substrate 210.

Semiconductor substrate 210 includes a plurality of pixels 220 that form a pixel array 220A, which is an example of pixel array 112A. Pixels 220 are arranged in a plurality of rows and columns along axes A1 and A2, respectively. Pixel array 220A has a diagonal pixel pitch 213 along axis A1. Along axis A2 pixel array 220A has pitch Py that, in embodiments, equals diagonal pixel pitch 213. In embodiments, diagonal pixel pitch 213 is between 1.0 μm to 3.0 μm, which corresponds to a range of standard pixel pitch between 0.7 μm to 2.0 μm. In embodiments, diagonal pixel pitch 213 is between 1.0 μm and 1.6 μm.

FIG. 3 is a circuit diagram of a four-transistor (“4T”) circuitry 310, which is a candidate pixel circuitry architecture of pixel 220. Circuitry 310 includes a photodiode PD1, a transfer transistor TX0, a reset transistor 306, and a row-select transistor 304. Circuitry 310 may also include a source-follower transistor 302. Circuitry 310 is electrically connected to a column bitline 308 of image sensor 192. FIGS. 2 and 3 are best viewed together in the following description.

In embodiments, each pixel 220 is one of multiple pixels of a pixel cell. FIG. 3 depicts a pixel cell 380, which is candidate pixel circuitry architecture for the pixel cell. Pixel cell 380 includes circuitry 310 and circuitry 315. Circuitry 315 includes at least one of additional photodiodes PD1-PD3 and transfer transistors TX1-TX3 of three additional pixels of the shared pixel-cell. Circuitry 315 is electrically connected to bitline 308. Circuitry 315 and circuitry 310 represent pixel circuitry for a pixel-cell 380. Herein, transfer transistor TX refers to one of transfer transistors TX0-TX3.

Each pixel 220 includes a respective photodiode 222, a respective transfer transistor (e.g., transfer transistor TX) having transfer gate 224, and a floating diffusion region 226. In embodiments, multiple pixels 220 share a common floating diffusion region 226, in which case the multiple pixels are part of a same pixel cell.

Photodiode 222 of each pixel 220 is at least partially embedded in pixel-array substrate 290 and is configured to generate and accumulate charges in response to incident light (illumination) thereon, for example, incident on bottom substrate surface 211 (e.g., backside surface of semiconductor substrate 210) during an integration period of the image sensor 192. Photodiode 222 is an example of any one of photodiodes PD0-PD3 of FIG. 3. In embodiments, photodiode 222 and floating diffusion region 226 are a source and a drain, respectively, of transfer transistor TX.

Electrical connection of photodiode 222 to floating diffusion region 226 depends on voltage applied to a transfer gate (e.g., transfer gate 224) of the respective transfer transistor (e.g., transfer transistor TX) associated with pixel 220. Charges, e.g., photoelectrons, photo-generated and accumulated in photodiode 222 of respective pixel 220 can be selectively transferred to floating diffusion region 226 depending on voltage applied to the transfer gate (e.g., transfer gate 224) of the respective transfer transistor associated with pixel 220, for example during a subsequent charge transfer period. Photodiode 222 may be in various configurations including, but not limited to, a pinned photodiode configuration and a partially pinned photodiode configuration. In embodiments, a pinning layer having conductivity opposed to photodiode 222 (e.g., the pinning layer is a p-type doped layer when photodiode 222 is n-type) is disposed between front substrate surface 219 of semiconductor substrate 210 and photodiode region of photodiode 222, wherein the pinning layer is coupled to a ground. In embodiments, charges accumulate in photodiode 222 during an integration period of image sensor 192.

A transfer gate (e.g., transfer gate 224) of each transfer transistor (e.g., vertical gate electrode of transfer transistor TX1) is formed in a respective trench defined by front substrate surface 219.

In embodiments, each pixel 220 is a pixel of pixel cell 380 and each pixel cell further includes reset transistor 306, source-follower transistor 302, and row-select transistor 304 shared by pixel 220 in pixel cell 380. In FIG. 3, reset transistor 306, source-follower transistor 302, and row-select transistor 304 are abbreviated as RS 306, SF 302, and RST 304, respectively. Reset transistor 306 is coupled between a power line and floating diffusion region 226 to reset (e.g., discharge residual charges in floating diffusion region 226 and charge floating diffusion region 226 to a preset voltage e.g., a supply voltage VDD) under control of a reset signal during a reset period. Reset transistor 306 is further coupled to photodiode 222 (e.g., one of photodiodes PD0-PD3) through the respective transfer transistor TX (e.g., transfer transistor TX0-TX3) to reset respective photodiode 222 to the preset voltage during the reset period. Floating diffusion region 226 is coupled to a gate of source-follower transistor 302. Source-follower transistor 302 is coupled between the power line and row-select transistor 304. Source-follower transistor 302 operates to modulate an image signal based on the voltage of floating diffusion region 226, where the image signal corresponds to the amount of photoelectrons accumulated in photodiode 222 of each pixel during the integration period at the gate thereof. Row-select transistor 304 selectively couples the output (e.g., image signal) of source-follower transistor 302 to the readout column line (for example, column bitline 308) under control of a row select signal.

In operation, during the integration period (also referred to as an exposure or accumulation period) of image sensor 192, photodiode 222 detects or absorbs light incident on pixel 220 and photogenerates one or more charges. During the integration period, each of the transfer transistors TX0-TX3 is turned off, i.e., transfer gate 224 of the respective transfer transistor TX0-TX3 receives a cut-off signal (e.g., a negative biasing voltage). The photogenerated charge accumulated in photodiode 222 is indicative of the amount of light incident on photodiode 222. After the integration period, each of the transfer transistors TX0-TX3 is turned on forming a conduction channel along the vertical transfer gate structure and transfers the photogenerated charge from photodiode 222 to floating diffusion region 226 through the conduction channel upon reception of a transfer signal (e.g., a positive biasing voltage) at transfer gate 224 of transfer transistors TX0-TX3. Source-follower transistor 302 generates the image signal based on accumulated charges in floating diffusion region 226. Row-select transistor 304 coupled to source-follower transistor 302 then selectively reads out the signal onto a column bitline 308 for subsequent image processing.

In embodiments, vertical transfer gate structures disclosed herein are part of a shared-type pixel cell where floating diffusion region 226 is shared by multiple photodiodes. Vertical transfer gate structures disclosed herein may apply to any of a variety of additional or alternative types of pixel cell, e.g., a four-transistor pixel cell, five-transistor pixel cell, or a six-transistor pixel cell.

FIG. 4 is a functional block diagram of an image sensor 400. Image sensor 400 is an example of image sensor 192. The cross-section illustrated in FIG. 4 is parallel to a plane formed by orthogonal axes A1 and A2, each of which is orthogonal to an axis A3. FIG. 4 also denotes a diagonal axes D1 and D2, each of which may be oriented at 45°with respect to each of axes A1 and A2.

Image sensor 400 includes two-dimensional array of pixels 420 that form a pixel array 420A. Pixel 420 is an example of pixel 220, FIG. 2. Pixel array 420A has M pixel rows 407(1−M) and N pixel columns 408(1−N), where are denoted in FIG. 4 as pixel rows R₁, R₂, . . . , R_{M} and pixel columns C₁, C₂, . . . , C_{N}, respectively. In some embodiments, pixel array 420A may be wider along axis A1 than along axis A2, which may result from N exceeding M. Pixel array 420A may be wider along axis A2 than along axis A1, which may result from M exceeding N. Image sensor 400 may include a semiconductor slab that includes pixel array 420A.

Image sensor 400 may also include at least one of readout circuitry 441, function logic 442, and control circuitry 443. After each pixel 420 has acquired its image charge, the image charge is read out by readout circuitry 441 through column bitlines and transferred to function logic 442. Image sensor 400 may further include control circuitry 443 coupled with pixel array 420A for generating various signals to control operation of each pixel 420. Control circuitry 443 may be electrically connected to pixel cell 380, and hence may also be electrically connected to each pixel cell of image sensor 400.

Each pixel 420 is denoted as pmn, where indices m and n of pixel coordinate (m, n) denote, respectively, the row and column of the pixel within pixel array 420A. For example, FIG. 4 denotes selected pixels 420 of pixel rows R1-R5 and pixel columns C1-C5.

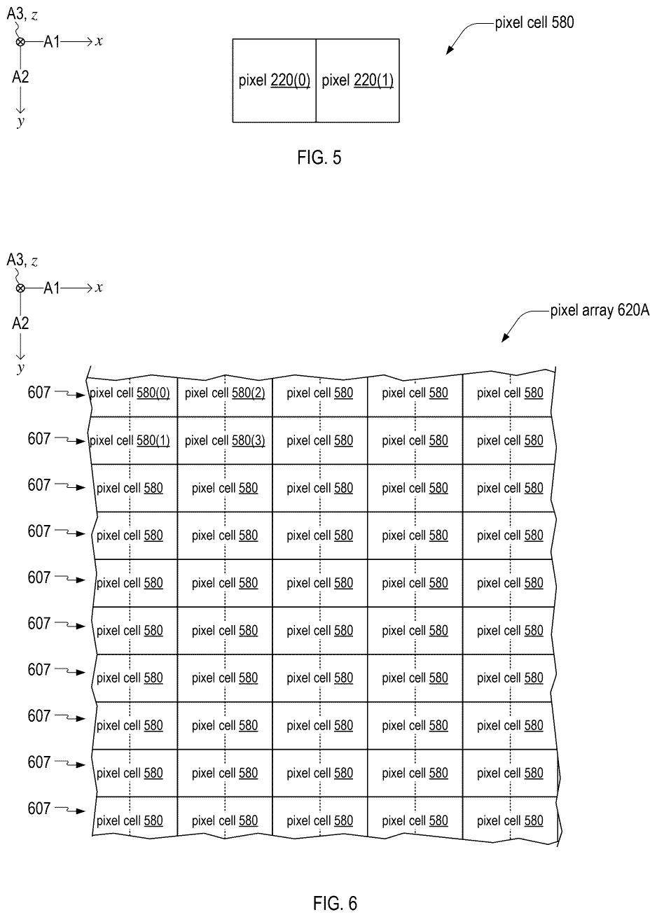

In embodiments, pixels 420 are grouped as pixel cells 580, as shown in FIG. 5, such that pixels 420 form a pixel array 620A, as shown in FIG. 6. Pixel cell 580 is an example of pixel cell 380 that includes PD0 and PD1.

Pixel array 620A is an example of pixel array 420A and includes multiple rows 607 of pixel cells 580. Each pixel 420 of pixel cell 580 shares a common floating diffusion region 226. Each pixel cell 580 may include a one-by-two sub-array or two-by-one sub-array of pixels 420. For example, FIG. 6 denotes pixel cells 580(0), 580(1), 580(2), and 580(3). Pixel cells 580(1), 580(2), and 580(3) are respectively vertically adjacent, horizontally adjacent, and diagonally adjacent to the pixel cell 580(0). In embodiments, pixel cell 580(0) includes pixel p11 and pixel p12; pixel cell 580(1) includes pixel p21 and pixel p22; pixel cell 580(2) includes pixel p13 and pixel p14; and pixel cell 580(3) includes pixel p23 and pixel p24. A pixel cell 580 may occupy two adjacent rows 407 and two adjacent columns 408 of pixel array 420A. In some embodiments, each individual pixel cell 580 may be disposed under a common type of color filter and under a same microlens. In the same or different embodiments, each individual pixel cell 580 may be referred as dual phase detection pixel or DPD pixel.

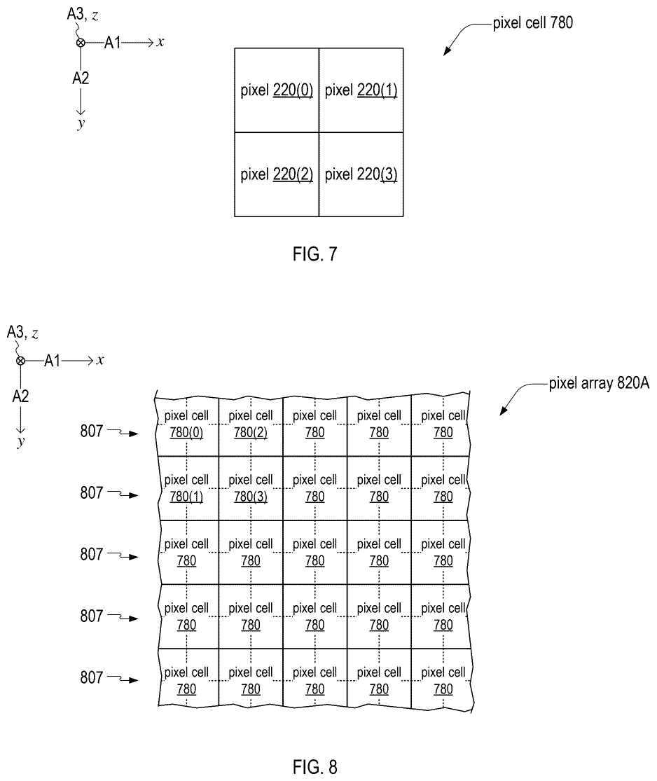

In embodiments, pixels 420 are grouped as pixel cells 780, as shown in FIG. 7, such that pixels 420 form a pixel array 820A, as shown in FIG. 8. Pixel cell 780 is an example of pixel cell 380 that includes PD0, PD1, PD2, and PD3.

Pixel array 820A is an example of pixel array 420A and includes multiple rows 807 of pixel cells 780. Each pixel 420 of pixel cell 780 shares a common floating diffusion region 226. Each pixel cell 780 may include a two-by-two sub-array of pixels 420. For example, FIG. 8 denotes pixel cells 780(0), 780(1), 780(2), and 780(3). Pixel cells 780(1), 780(2), and 780(3) are respectively vertically adjacent, horizontally adjacent, and diagonally adjacent to the pixel cell 780(0). In embodiments, pixel cell 780(0) includes pixels p11, P12, P21, and p22; pixel cell 780(1) includes pixels p31, P32, P41, and p42; pixel cell 780(2) includes pixels p13, P14, P23, and p24; and pixel cell 780(3) includes pixels p33, P34, P43, and p44. A pixel cell 780 may occupy two adjacent rows 407 and two adjacent columns 408 of pixel array 420A. In some embodiments, each individual pixel cell 780 may be disposed under a common type of color filter and under a same microlens. In the same or different embodiments, each individual pixel cell 780 may be referred as quad phase detection pixel or QPD pixel.

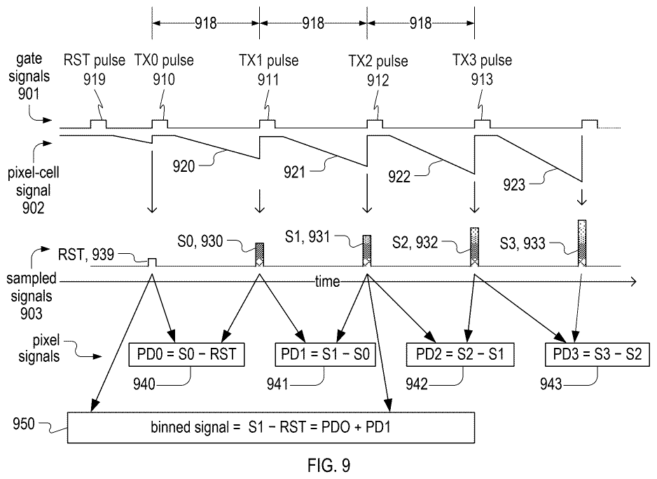

FIG. 9 is a plot of gate signals 901, a pixel cell signal 902, and sampled signals 903. Gate signals 901 may be applied to pixel cell 580 or pixel cell 780, which cause the pixel cell to produce pixel cell signal 902. Gate signals 901 include a reset pulse 919, and at least two of a TX0 pulse 910, a TX1 pulse 911 a TX2 pulse 912 and a TX3 pulse 913. Transfer-gate pulses 910-913 may be applied to transfer gates TX0-TX3, respectively, of pixel cell 380. Transfer-gate pulses 910-913 are temporally spaced by a sampling period 918.

Pixel cell signal 902 include ramp regions 920, 921, 922, and 923, the respective slopes of which are determined by photocurrent output by pixels of the pixel cell. When the pixel cell is pixel cell 580, the photocurrent output by pixels 220(0) and 220(1) may determine the respective slopes of ramp regions 920 and 921. When the pixel cell is pixel cell 780, the photocurrent output by pixels 220(0)-220(3) may determine the respective slopes of ramp regions 920-923.

Readout circuitry 441, such as an analog-to-digital converter thereof, samples pixel cell signal 902 and outputs sampled signals 903 as a result of said sampling. Sampled signals 903 include a reset signal RST, at least two of a signal S0, a signal S1, a signal S2, and a signal S3. Reset signal RST is also denoted as a reset signal 939; signals S0-S3 are also denoted as signals 930-933, respectively. In embodiments, the respective magnitudes of signals S0-S3 are proportional to the respective slopes of ramp regions 920-923, as illustrated schematically in FIG. 9. FIG. 9 denotes pixel signals PD0, PD1, PD2, and PD3, each of which is a difference between two of reset signal RST and signals S0, S1, S2, and S3. Pixel signals PD0-PD3 are also denoted as pixel signals 940-943, respectively, and are examples of image data. FIG. 9 also denotes a binned signal 950, which is reset signal RST subtracted from signal S1.

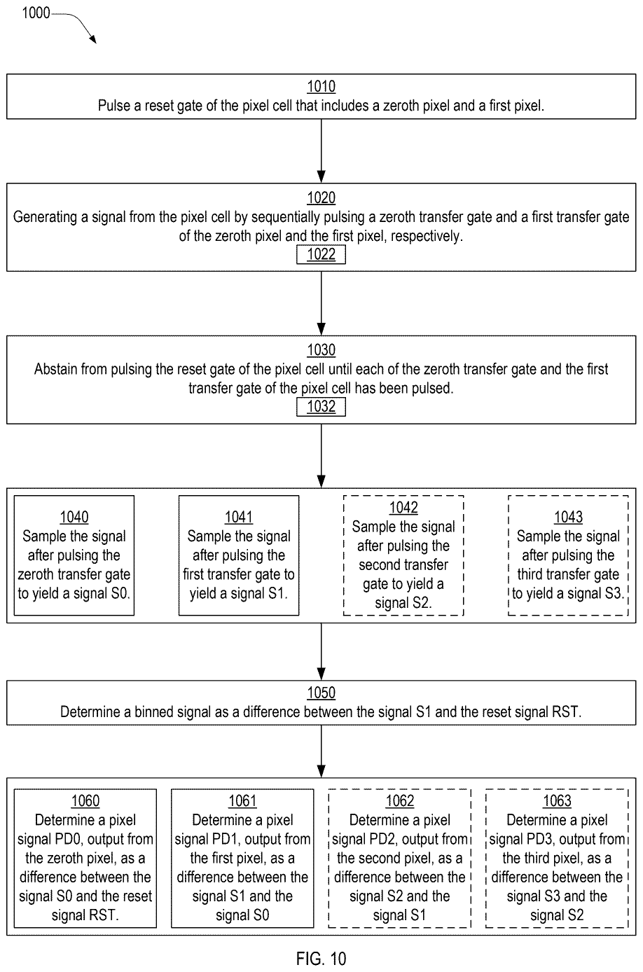

FIG. 10 is a flowchart illustrating a method 1000 for generating image data from a pixel cell of an image sensor. Method 1000 may be implemented by image sensor 400 that has either a plurality of pixel cells, such as pixel cell 580 or pixel cell 780. Control circuitry 443 may implement method 1000.

Descriptions of method 1000 and subsequent methods disclosed herein include parenthetical numbers following terms used in a method step. The parenthetical number indicates that the element associated with the number in parenthesis is an example of the term. For example, the description of step 1010 below recites “pulsing a reset gate (306),” which means that reset gate 306 of FIG. 3 is an example of the reset gate introduced in step 1010.

Step 1010 includes pulsing a reset gate (306) of the pixel cell (580, 780) that includes a zeroth pixel (220(0)) and a first pixel (220(1)). Step 1020 includes generating a signal (902) from the pixel cell by sequentially pulsing a zeroth transfer gate (TX0) and a first transfer gate (TX1) of the zeroth pixel and the first pixel, respectively. Step 1030 includes abstaining from pulsing the reset gate of the pixel cell until each of the zeroth transfer gate and the first transfer gate of the pixel cell has been pulsed. Step 1030 may include pulsing the reset gate after each of the zeroth transfer gate and the first transfer gate of the pixel cell has been pulsed.

Step 1040 includes sampling the signal after pulsing the zeroth transfer gate to yield a signal S0 (930). Step 1041 includes sampling the signal after pulsing the first transfer gate to yield a signal S1 (931). Step 1043 includes sampling the signal after pulsing the reset gate to yield a reset signal RST (939).

Step 1050 includes determining a binned signal (950) as a difference between the signal S1 and the reset signal RST.

Step 1060 includes determining a pixel signal PD0 (940), output from the zeroth pixel, as a difference between the signal S0 and the reset signal RST. Step 1061 includes determining a pixel signal PD1 (941), output from the first pixel, as a difference between the signal S1 and the signal S0. Pixel signals PD0 and PD1 are examples of image data.

Method 1000 may include additional steps when the pixel cell includes a second pixel and a third pixel, for example, when the pixel cell is pixel cell 780, FIG. 7. In such embodiments, method 1000 may include at least one of steps 1022, 1032, 1042, 1043, 1062, and 1063. Steps 1022 and 1032 are part of steps 1020 and 1030, respectively. Step 1022 includes sequentially pulsing a second transfer gate (TX2) and a third transfer gate (TX3) of the second pixel (220(2)) and the third pixel (220(3)), respectively. Step 1032 includes abstaining from pulsing the reset gate until each of the second transfer gate and the third transfer gate of the pixel cell has been pulsed. Step 1032 may include pulsing the reset gate after each of the second transfer gate and the third transfer gate of the pixel cell has been pulsed.

Step 1042 includes sampling the signal after pulsing the second transfer gate to yield a signal S2 (932). Step 1043 includes sampling the signal after pulsing the third transfer gate to yield a signal S3 (933). Step 1062 includes determining a pixel signal PD2 (942), output from the second pixel, as a difference between the signal S2 and the signal S1. Step 1063 includes determining a pixel signal PD3 (943), output from the third pixel, as a difference between the signal S3 and the signal S2.

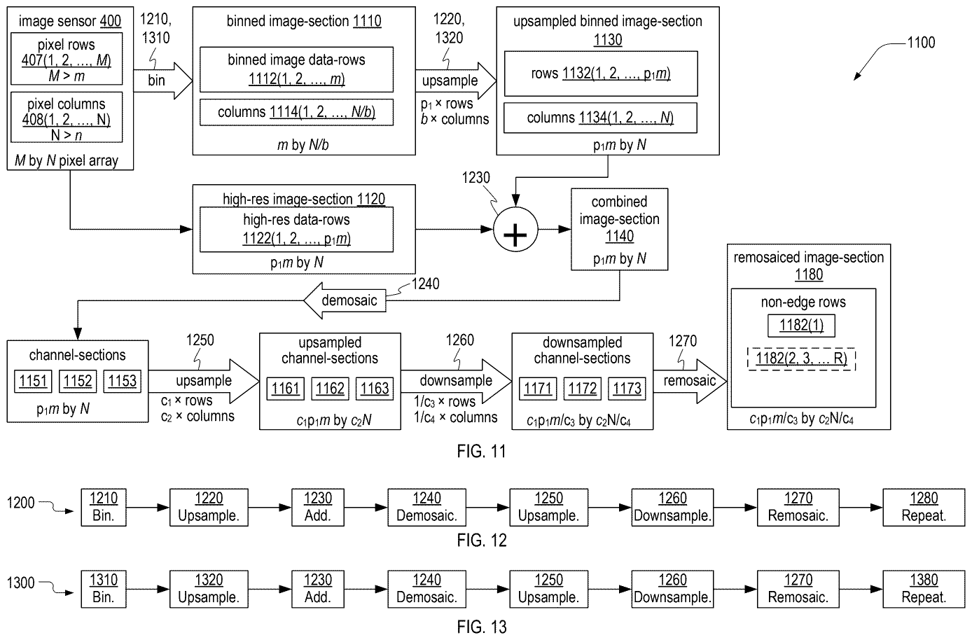

FIG. 11 is a data-flow diagram 1100 and FIG. 12 is a flowchart illustrating a method 1200 for generating a middle-resolution image. Method 1200 may be implemented by an embodiment of image sensor 400 that includes pixel cells 580, FIG. 5. FIGS. 11 and 12 are best viewed together in the following description. Control circuitry 443 may implement method 1200.

Data-flow diagram 1100 includes image sensor 400, a binned image-section 1110, a high-res image-section 1120, an upsampled binned image-section 1130, a combined image-section 1140, channel-sections 1151, 1152, and 1153, upsampled channel-sections 1161, 1162, and 1163, downsampled channel-sections 1171, 1172, and 1173, and a remosaiced image-section 1180. Binned image-section 1110 and high-res image-section 1120 may be stored in a line buffer of image sensor 400. Herein, “high-res” is short for “high-resolution.”

Binned image-section 1110 has m rows and N/b columns, and includes binned image data-rows 1112(1, 2, . . . , m), and columns 1114(1, 2, . . . N/b), where b is a binning factor and m is a positive integer less than the number of rows M of image sensor 400.

Binning factor b is less than the number of columns N of image sensor 400, and may be a factor of N. In embodiments, b=2. Upsampled binned image-section 1130 has rows 1132(1, 2, . . . , p₁m) and columns 1134(1, 2, . . . , N), where upsampling factor p₁ is a positive integer. In embodiments, the number of columns of image section 1130 equals the number of columns of binned image-section 1110 times binning factor b. In such embodiments, upsampling binned image-section 1110 to upsampled binned image-section 1130 (e.g., steps 1220, and 1320 described below) includes upsampling the number of columns by binning factor b.

In embodiments, and least one of M and N exceeds one thousand, e.g., M may equal 6,000 and N may equal 8,000. In embodiments, image sensor 400 has pixel cells 580 and upsampling factor p₁ equals one. In embodiments, image sensor 400 has pixel cells 780 and upsampling factor p₁ equals two.

High-res image-section 1120 has p₁m high-res data-rows 1122(1, 2, . . . p₁m).

Combined image-section 1140 and each of channel-sections 1151-1153 have m rows and N columns. Each of upsampled channel-sections 1161-1163 has c₁m rows and c₂N columns, where c₁ and c₂ are positive integers. In embodiments, c₁ and c₂ equal two and three, respectively.

Each of downsampled channel-sections 1171-1173 and remosaiced image-section 1180 has c₁m/c₃ rows and c₂N/c₄ columns, where c₃ and c₄ are positive integers and may be factors of c₁ and c₂, respectively. For example, c₃ may equal c₂. In embodiments, c₃ and c₄ equal three and four, respectively.

Method 1200 includes at least one of steps 1210, 1220, 1230, 1240, 1250, 1260, 1270, and 1280. Step 1210 includes generating (i) a binned image-section (1110) that includes a plurality of binned-image data-rows (1112) and (ii) a high-res image-section (1120) that includes a plurality high-res data-rows (1122). The binned image-section (1110) is generated by, for each row of multiple rows (607) of pixel cells (580) of the image sensor, m₁ in number, of the image sensor (400): generating one of the plurality of binned-image data-rows (1112) and one of the plurality high-res data-rows (1122) by, for each of a plurality of pixel cells (580) of the row of pixel cells, executing method 1000. Each pixel value of the binned-image data-row (1112) is the binned signal (940) associated with the pixel cell (580). Pixel values of the high-res data-row include the pixel signal PD0 and the pixel signal PD1 of the pixel cell. The number of rows M_{c} of pixel cells may exceed m₁. Herein, res is short for resolution.

Step 1220 includes upsampling the binned image-section to yield an upsampled binned image-section (1130) having twice as many columns (1134) as the binned image-section (1110). Step 1230 includes adding the upsampled binned image-section to the high-res image-section to yield a combined image-section (1140).

Step 1240 includes demosaicing the combined image-section to yield a first channel-section (1151), a second channel-section (1152), and a third channel-section (1153) that correspond, respectively, to a first, a second, and a third color filter type of the image sensor. Step 1250 includes upsampling each of the first, the second, and the third channel-sections to yield a first upsampled channel-section (1161), a second upsampled channel-section (1162), and a third upsampled channel-section (1163), respectively. Step 1260 includes downsampling the first, the second, and the third upsampled channel-sections to yield a first, a second, and a third downsampled channel-section (1171, 1172, 1173). Step 1270 includes generating a remosaiced image-section (1180) by combining, via remosaicing, the first, the second, and the third downsampled channel-sections, a non-edge row (1182(1)) of the remosaiced image-section being a row of the middle-resolution image.

Method 1200 may include producing additional non-edge rows of the middle-resolution image by, for each row of multiple rows of pixel cells of the image sensor, m₂ in number, executing step 1280. Step 1280 includes repeating steps 1210, 1220, 1230, 1240, 1250, 1260, and 1270 to produce additional non-edge rows that make up the middle-resolution image. In embodiments, the image sensor is part of a system-on-chip (SOC), and image sensor sends these additional non-edge rows to the system side of the SOC, to a host processor for example. The system side and the image sensor may communicate via a MIPI-compliant interface. The number of rows Mc of pixel cells may exceed m₂.

FIG. 13 is a flowchart illustrating a method 1300 for generating a middle-resolution image. Method 1300 may be implemented by an embodiment of image sensor 400 that includes pixel cells 780, FIG. 7. Control circuitry 443 may implement method 1300.

Method 1300 includes at least one of steps 1310, 1320, and 1380, which are similar to steps 1210, 1220, and 1280 of method 1200, respectively. Method 1300 also includes at least one of steps 1230, 1240, 1250, 1260, and 1270 introduced above in the description of method 1200.

Step 1310 includes generating (i) a binned image-section (1110) that includes a plurality of binned-image data-rows (1112) and a (ii) high-res image-section (1120) that includes a plurality high-res data-rows (1122). The binned image-section (1110) is generated by, for each row of multiple rows (807) of pixel cells (780), m₁ in number, of the image sensor (400): generating (i) one of the plurality of binned-image data-rows (1112) and (ii) a first and a second row of the plurality high-res data-rows (1122) by, for each of a plurality of pixel cells (780) of the row of pixel cells, executing an embodiment method 1000 that includes steps 1022, 1032, 1042, 1043, 1062, and 1063. Each pixel value of the binned-image data-row (1112) is the binned signal (940) associated with the pixel cell (780). Pixel values of the first row include the pixel signals PD0 and PD1 of the pixel cell. Pixel values of the second row include the pixel signals PD2 and PD3 of the pixel cell.

Step 1320 includes upsampling the binned image-section to yield an upsampled binned image-section (1130) having twice as many rows and twice as many columns (1134) as the binned image-section (1110). In example of step 1320, binning factor b=2 and upsampling factor p1 =2, which are shown in binned image-section 1110 and upsampled image-section 1130, respectively, of FIG. 11.

In method 1300, the steps between steps 1320 and 1380 may include at least one of steps 1230-1270. Method 1300 may include producing additional non-edge rows of the middle-resolution image by, for each row of multiple rows of pixel cells of the image sensor, m₂ in number, executing step 1380. Step 1380 includes repeating steps 1310, 1320, 1230, 1240, 1250, 1260, and 1270 produce additional non-edge rows that make up the middle-resolution image. In embodiments, the image sensor is part of a system-on-chip (SOC), and image sensor sends these additional non-edge rows to the system side of the SOC, to a host processor for example. The system side and the image sensor may communicate via a MIPI-compliant interface. The number of rows Mc of pixel cells may exceed m₂.

### Combinations of Features

Features described above, as well as those claimed below, may be combined in various ways without departing from the scope hereof. The following enumerated examples illustrate some possible, non-limiting combinations.

Embodiment 1. A method for generating image data from a pixel cell of an image sensor, comprising: pulsing a reset gate, of the pixel cell, that includes a zeroth pixel and a first pixel; generating a signal from the pixel cell by sequentially pulsing a zeroth transfer gate and a first transfer gate of the zeroth pixel and the first pixel, respectively; abstaining from pulsing the reset gate of the pixel cell until each of the zeroth transfer gate and the first transfer gate of the pixel cell has been pulsed; sampling the signal after pulsing the zeroth transfer gate to yield a signal S0; sampling the signal after pulsing the first transfer gate to yield a signal S1; sampling the signal after pulsing the reset gate to yield a reset signal RST; determining a binned signal as a difference between the signal S1 and the reset signal RST; determining a pixel signal PD0, output from the zeroth pixel, as a difference between the signal S0 and the reset signal RST; and determining a pixel signal PD1, output from the first pixel, as a difference between the signal S1 and the signal S0.

Embodiment 2. A method for generating a middle-resolution image comprising: generating (i) a binned image-section that includes a plurality of binned-image data-rows and (ii) a high-res image-section that includes a plurality high-res data-rows by, for each row of multiple rows of pixel cells of the image sensor, m₁ in number, of the image sensor of embodiment 1: generating one of the plurality of binned-image data-rows and one of the plurality high-res data-rows by, for each of a plurality of pixel cells of the row of pixel cells, executing the method of embodiment 1, each pixel value of the binned-image data-row being the binned signal associated with the pixel cell, and pixel values of the high-res data-row including the pixel signal PD0 and the pixel signal PD1 of the pixel cell; upsampling the binned image-section to yield an upsampled binned image-section having twice as many columns as the binned image-section and adding the upsampled binned image-section to the high-res image-section to yield a combined image-section.

Embodiment 3. The method of embodiment 2, further comprising: demosaicing the combined image-section to yield a first channel-section a second channel-section and a third channel-section that correspond, respectively, to a first, a second, and a third color filter type of the image sensor; upsampling each of the first, the second, and the third channel-sections to yield a first upsampled channel-section a second upsampled channel-section and a third upsampled channel-section, respectively; downsampling the first, the second, and the third upsampled channel-sections to yield a first, a second, and a third downsampled channel-section; and generating a remosaiced image-section by combining, via remosaicing, the first, the second, and the third downsampled channel-sections. A non-edge row of the remosaiced image-section is a row of the middle-resolution image.

Embodiment 4. The method of either one of embodiments 2 or 3, further comprising producing additional non-edge rows of the middle-resolution image by, for each row of multiple rows of pixel cells of the image sensor, m₂ in number: repeating said (i) generating a binned image-section and the high-res image-section (ii) upsampling the binned image-section, (iii) adding, (iv) demosaicing, (v) upsampling each of the first, the second, and the third channel-sections, (vi) downsampling each of the first, the second, and the third upsampled channel-sections, and (vii) generating the remosaiced image to produce additional non-edge rows that make up the middle-resolution image.

Embodiment 5. The method of embodiment 4, the image sensor including Mc rows of pixel cells, wherein M_{c} exceeds m₂.

Embodiment 6. The method of any one of embodiments 2-5, the image sensor including M_{c} rows of pixel cells, wherein M_{c} exceeds m₁.

Embodiment 7. The method of any one of embodiments 2-6, the pixel cell further including a second pixel and a third pixel, generating the signal further comprising sequentially pulsing a second transfer gate and a third transfer gate of the second pixel and the third pixel, respectively; abstaining further comprising abstaining from pulsing the reset gate until each of the second transfer gate and the third transfer gate of the pixel cell has been pulsed; and the method further comprising: sampling the signal after pulsing the second transfer gate to yield a signal S2; sampling the signal after pulsing the third transfer gate to yield a signal S3; determining a pixel signal PD2, output from the second pixel, as a difference between the signal S2 and the signal S1; and determining a pixel signal PD3, output from the third pixel, as a difference between the signal S3 and the signal S2.

Embodiment 8. A method for generating a middle-resolution image comprising: generating (i) a binned image-section that includes a plurality of binned-image data-rows and a (ii) high-res image-section that includes a plurality high-res data-rows by, for each row of multiple rows of pixel cells, m₁ in number, of the image sensor of embodiment 7: generating (i) one of the plurality of binned-image data-rows and (ii) a first and a second row of the plurality high-res data-rows by, for each of a plurality of pixel cells of the row of pixel cells, executing the method of embodiment 7, each pixel value of the binned-image data-row being the binned signal associated with the pixel cell pixel values of the first row including the pixel signals PD0 and PD1 of the pixel cell, pixel values of the second row including the pixel signals PD2 and PD3 of the pixel cell; upsampling the binned image-section to yield an upsampled binned image-section having twice as many rows and twice as many columns as the binned image-section; and adding the upsampled binned image-section to the high-res image-section to yield a combined image-section

Embodiment 9. The method of embodiment 8, further comprising: demosaicing the combined image-section to yield a first channel-section, a second channel-section, and a third channel-section that correspond, respectively, to a first, a second, and a third color filter type of the image sensor; upsampling each of the first, the second, and the third channel-sections to yield a first upsampled channel-section, a second upsampled channel-section, and a third upsampled channel-section, respectively; downsampling the first, the second, and the third upsampled channel-sections to yield a first, a second, and a third downsampled channel-section; and generating a remosaiced image-section by combining, via remosaicing, the first, the second, and the third downsampled channel-sections, a non-edge row of the remosaiced image-section being a row of the middle-resolution image.

Embodiment 10. The method of either one of embodiments 8 or 9, further comprising producing additional non-edge rows of the middle-resolution image by, for each row of multiple rows of pixel cells of the image sensor, m₂ in number: repeating said (i) generating a binned image-section and the high-res image-section (ii) upsampling the binned image-section, (iii) adding, (iv) demosaicing, (v) upsampling each of the first, the second, and the third channel-sections, (vi) downsampling each of the first, the second, and the third upsampled channel-sections, and (vii) generating the remosaiced image to produce additional non-edge rows that make up the middle-resolution image.

Embodiment 11. The method of embodiment 10, the image sensor including M_{c} rows of pixel cells, wherein exceeds m₂.

Embodiment 12. An image sensor comprising: a pixel cell of any one of embodiments 1-11; and control circuitry, electrically connected to the pixel cell, that executes the method of any one of claims 1-11.

Embodiment 13. An image sensor comprising: a pixel array having a plurality pixel cells of embodiments 1-11, and control circuitry that (i) is electrically connected to each of the plurality of pixel cells and (ii) executes the method of any one of embodiments 1-11 for each of the plurality of pixel cells.

Embodiment 14. An image sensor comprising: a pixel array having a plurality pixel cells of embodiment 1; and control circuitry that (i) is electrically connected to each of the plurality of pixel cells and (ii) generates a middle-resolution image by executing the method of embodiment 2.

Embodiment 15. An image sensor comprising: a pixel cell of embodiment 7;and control circuitry, electrically connected to the pixel cell, that executes the method of embodiment 7.

Embodiment 16. An image sensor comprising: a pixel array having a plurality pixel cells of embodiment 7; and control circuitry that (i) is electrically connected to each of the plurality of pixel cells and (ii) executes the method of embodiment 7 for each of the plurality of pixel cells.

Embodiment 17. An image sensor comprising: a pixel array having a plurality pixel cells of embodiment 8; and control circuitry that (i) is electrically connected to each of the plurality of pixel cells and (ii) generates a middle-resolution image by executing the method of embodiment 8.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C, ” “at least one of A, B, and C,” and “at least one of A, B, or C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

1. A method for generating image data from a pixel cell of an image sensor, comprising:
pulsing a reset gate, of the pixel cell, that includes a zeroth pixel and a first pixel;
generating a signal from the pixel cell by sequentially pulsing a zeroth transfer gate and a first transfer gate of the zeroth pixel and the first pixel, respectively;
abstaining from pulsing the reset gate of the pixel cell until each of the zeroth transfer gate and the first transfer gate of the pixel cell has been pulsed;
sampling the signal after pulsing the zeroth transfer gate to yield a signal S0;
sampling the signal after pulsing the first transfer gate to yield a signal S1;
sampling the signal after pulsing the reset gate to yield a reset signal RST;
determining a binned signal as a difference between the signal S1 and the reset signal RST;
determining a pixel signal PD0, output from the zeroth pixel, as a difference between the signal S0 and the reset signal RST; and
determining a pixel signal PD1, output from the first pixel, as a difference between the signal S1 and the signal S0.

2. A method for generating a middle-resolution image comprising:
generating (i) a binned image-section that includes a plurality of binned-image data-rows and (ii) a high-res image-section that includes a plurality high-res data-rows by, for each row of multiple rows of pixel cells of the image sensor, m₁ in number, of the image sensor of claim 1:
generating one of the plurality of binned-image data-rows and one of the plurality high-res data-rows by, for each of a plurality of pixel cells of the row of pixel cells, executing the method of claim 1,
each pixel value of the binned-image data-row being the binned signal associated with the pixel cell, and pixel values of the high-res data-row including the pixel signal PD0 and the pixel signal PD1 of the pixel cell;
upsampling the binned image-section to yield an upsampled binned image-section having twice as many columns as the binned image-section and
adding the upsampled binned image-section to the high-res image-section to yield a combined image-section.

3. The method of claim 2, further comprising:
demosaicing the combined image-section to yield a first channel-section a second channel-section and a third channel-section that correspond, respectively, to a first, a second, and a third color filter type of the image sensor;
upsampling each of the first, the second, and the third channel-sections to yield a first upsampled channel-section, a second upsampled channel-section, and a third upsampled channel-section, respectively;
downsampling the first, the second, and the third upsampled channel-sections to yield a first, a second, and a third downsampled channel-section; and
generating a remosaiced image-section by combining, via remosaicing, the first, the second, and the third downsampled channel-sections, wherein a non-edge row of the remosaiced image-section is a row of the middle-resolution image.

4. The method of claim 3, further comprising producing additional non-edge rows of the middle-resolution image by, for each row of multiple rows of pixel cells of the image sensor, m₂ in number:
repeating said (i) generating a binned image-section and the high-res image-section (ii) upsampling the binned image-section, (iii) adding, (iv) demosaicing, (v) upsampling each of the first, the second, and the third channel-sections, (vi) downsampling each of the first, the second, and the third upsampled channel-sections, and (vii) generating the remosaiced image to produce additional non-edge rows that make up the middle-resolution image.

5. The method of claim 4, the image sensor including M_{c} rows of pixel cells, wherein M_{c} exceeds m₂.

6. The method of claim 2, the image sensor including M_{c} rows of pixel cells, wherein M_{c} exceeds m₁.

7. The method of claim 1, the pixel cell further including a second pixel and a third pixel,
generating the signal further comprising sequentially pulsing a second transfer gate and a third transfer gate of the second pixel and the third pixel, respectively;
abstaining further comprising abstaining from pulsing the reset gate until each of the second transfer gate and the third transfer gate of the pixel cell has been pulsed;
and the method further comprising:
sampling the signal after pulsing the second transfer gate to yield a signal S2;
sampling the signal after pulsing the third transfer gate to yield a signal S3;
determining a pixel signal PD2, output from the second pixel, as a difference between the signal S2 and the signal S1; and
determining a pixel signal PD3, output from the third pixel, as a difference between the signal S3 and the signal S2.

8. A method for generating a middle-resolution image comprising:
generating (i) a binned image-section that includes a plurality of binned-image data-rows and a (ii) high-res image-section that includes a plurality high-res data-rows by, for each row of multiple rows of pixel cells, m₁ in number, of the image sensor of claim 7:
generating (i) one of the plurality of binned-image data-rows and (ii) a first and a second row of the plurality high-res data-rows by, for each of a plurality of pixel cells of the row of pixel cells, executing the method of claim 7,
each pixel value of the binned-image data-row being the binned signal associated with the pixel cell pixel values of the first row including the pixel signals PD0 and PD1 of the pixel cell, pixel values of the second row including the pixel signals PD2 and PD3 of the pixel cell;
upsampling the binned image-section to yield an upsampled binned image-section having twice as many rows and twice as many columns as the binned image-section; and
adding the upsampled binned image-section to the high-res image-section to yield a combined image-section.

9. The method of claim 8, further comprising:
demosaicing the combined image-section to yield a first channel-section, a second channel-section, and a third channel-section that correspond, respectively, to a first, a second, and a third color filter type of the image sensor;
upsampling each of the first, the second, and the third channel-sections to yield a first upsampled channel-section, a second upsampled channel-section, and a third upsampled channel-section, respectively;
downsampling the first, the second, and the third upsampled channel-sections to yield a first, a second, and a third downsampled channel-section; and
generating a remosaiced image-section by combining, via remosaicing, the first, the second, and the third downsampled channel-sections, a non-edge row of the remosaiced image-section being a row of the middle-resolution image.

10. The method of claim 9, further comprising producing additional non-edge rows of the middle-resolution image by, for each row of multiple rows of pixel cells of the image sensor, m₂ in number:
repeating said (i) generating a binned image-section and the high-res image-section (ii) upsampling the binned image-section, (iii) adding, (iv) demosaicing, (v) upsampling each of the first, the second, and the third channel-sections, (vi) downsampling each of the first, the second, and the third upsampled channel-sections, and (vii) generating the remosaiced image to produce additional non-edge rows that make up the middle-resolution image.

11. The method of claim 10, the image sensor including M_{c} rows of pixel cells, wherein M_{c} exceeds m₂.

12. An image sensor comprising:
a pixel cell of claim 1; and
control circuitry, electrically connected to the pixel cell, that executes the method of claim 1.

13. An image sensor comprising:
a pixel array having a plurality pixel cells of claim 1, and control circuitry that (i) is electrically connected to each of the plurality of pixel cells and (ii) executes the method of claim 1 for each of the plurality of pixel cells.

14. An image sensor comprising:
a pixel array having a plurality pixel cells of claim 1; and
control circuitry that (i) is electrically connected to each of the plurality of pixel cells and (ii) generates a middle-resolution image by:
generating (i) a binned image-section that includes a plurality of binned-image data-rows and (ii) a high-res image-section that includes a plurality high-res data-rows by, for each row of multiple rows of pixel cells of the image sensor, m₁ in number, of the image sensor of claim 1:
generating one of the plurality of binned-image data-rows and one of the plurality high-res data-rows by, for each of a plurality of pixel cells of the row of pixel cells, executing the method of claim 1,
each pixel value of the binned-image data-row being the binned signal associated with the pixel cell, and pixel values of the high-res data-row including the pixel signal PD0 and the pixel signal PD1 of the pixel cell;
upsampling the binned image-section to yield an upsampled binned image-section having twice as many columns as the binned image-section and
adding the upsampled binned image-section to the high-res image-section to yield a combined image-section.

15. An image sensor comprising:
a pixel cell of claim 7; and
control circuitry, electrically connected to the pixel cell, that executes the method of claim 7.

16. An image sensor comprising:
a pixel array having a plurality pixel cells of claim 7; and
control circuitry that (i) is electrically connected to each of the plurality of pixel cells and (ii) executes the method of claim 7 for each of the plurality of pixel cells.

17. An image sensor comprising:
a pixel array having a plurality pixel cells of claim 8; and
control circuitry that (i) is electrically connected to each of the plurality of pixel cells and (ii) generates a middle-resolution image by:
generating (i) a binned image-section that includes a plurality of binned-image data-rows and a (ii) high-res image-section that includes a plurality high-res data-rows by, for each row of multiple rows of pixel cells, m₁ in number, of the image sensor of claim 7:
generating (i) one of the plurality of binned-image data-rows and (ii) a first and a second row of the plurality high-res data-rows by, for each of a plurality of pixel cells of the row of pixel cells, executing the method of claim 7,
each pixel value of the binned-image data-row being the binned signal associated with the pixel cell pixel values of the first row including the pixel signals PD0 and PD1 of the pixel cell, pixel values of the second row including the pixel signals PD2 and PD3 of the pixel cell;
upsampling the binned image-section to yield an upsampled binned image-section having twice as many rows and twice as many columns as the binned image-section; and
adding the upsampled binned image-section to the high-res image-section to yield a combined image-section.
